(19) United States
(12) Patent Application Publication
(10) Pub. No.: US 2025/0148258 A1
(43) Pub. Date: May 8, 2025

(54) LARGE LANGUAGE MODEL CONFIGURED TO DIRECT DOMAIN-SPECIFIC QUERIES TO DOMAIN-SPECIFIC EDGE MODELS

(71) Applicant: Halliburton Energy Services, Inc., Houston, TX (US)

(72) Inventors: Christopher Michael JONES, Houston, TX (US); Ning TU, Singapore (SG)

(73) Assignee: Halliburton Energy Services, Inc., Houston, TX (US)

(21) Appl. No.: 18/386,416

(22) Filed: Nov. 2, 2023

(51) Int. Cl. G06N 3/006; G06N 3/042; G06N 3/0455; G06N 3/08

(52) U.S. Cl. CPC G06N 3/006; G06N 3/042; G06N 3/0455; G06N 3/08

(57) ABSTRACT

Described herein are systems and techniques for implementing a petrophysics assistant. An example method can include receiving, by a control language model configured to perform natural language processing, a query related to one or more subject areas; based on the one or more subject areas associated with the query and a respective domain-specific knowledge of each domain-specific language model from a plurality of domain-specific language models, selecting one or more domain-specific language models from the plurality of domain-specific language models to answer the query; sending, to the one or more domain-specific language models, a request to answer the query; and generating, by the control language model, a response to the query based on one or more responses to the query received from the one or more domain-specific language models.

### TECHNICAL FIELD

The present disclosure generally relates to large language models used as assistants for various applications. For example, aspects of the present disclosure relate to systems and techniques for implementing large language models configured to direct domain-specific queries to domain-specific edge models.

### BACKGROUND

To manage oil and gas drilling and production environments (e.g., wellbores, etc.) and perform operations in the oil and gas drilling and production environments, operators typically obtain and evaluate various types of data, such as measurements and other sensor data, to gain insights about Earth formations and conditions in a wellbore. For example, sensor data can be used to identify features within an Earth formation and other details about a wellbore and/or associated operations. However, the downhole conditions in a wellbore and associated constraints can create significant challenges in monitoring conditions downhole and deploying systems in the wellbore, such as sensors and other wellbore tools. Some example downhole conditions and constraints in a wellbore can include extreme temperatures, extreme pressures, space constraints, formation resistivity, formation conductivity, formation permeability, and complex mixtures of different elements, among others. Generally, certain computing resources may be used to obtain information used to manage a wellbore environment and/or perform wellbore operations. The computations used to make or facilitate such determinations and estimates can be resource intensive and can cause expensive delays, which can increase costs and impact wellbore operations.

### BRIEF DESCRIPTION OF THE DRAWINGS

Illustrative examples and aspects of the present application are described in detail below with reference to the following figures:

FIG. 1A is a schematic side-view of an example wireline logging environment, according to some examples of the present disclosure;

FIG. 1B is a schematic side-view of the example logging environment of FIG. 1A, according to some examples of the present disclosure;

FIG. 2 is a diagram illustrating an example architecture of an example petrophysics assistant, according to some examples of the present disclosure;

FIG. 3 is a diagram illustrating an example system for generating training data used to train a large language model, according to some examples of the present disclosure;

FIG. 4 is a diagram illustrating an example use of a petrophysics assistant, according to some examples of the present disclosure;

FIG. 5 illustrates an example neural network, according to some examples of the present disclosure;

FIG. 6 is a diagram illustrating an example model architecture that can be used to implement a large language model, according to some examples of the present disclosure;

FIG. 7 is a flowchart illustrating an example process for implementing a petrophysics assistant, according to some examples of the present disclosure; and

FIG. 8 illustrates an example computing device and hardware that can be used to implement some aspects of the disclosed technology.

### DETAILED DESCRIPTION

Various aspects and examples of the disclosure are discussed in detail below. While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one embodiment or an embodiment, one aspect or an aspect, or one example or an example in the present disclosure can refer to the same embodiment/example/aspect/etc., or any embodiment/example/aspect/etc., and such references mean at least one of the embodiments, examples, and/or aspects.

Moreover, reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Also, various features are described which may be exhibited by some embodiments and not by others.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, techniques, systems, apparatuses, methods (also referred to as processes herein), non-transitory computer-readable media, and their related results according to the examples and aspects of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Petrophysics is a branch of geosciences that focuses on studying and understanding the physical properties of rocks and fluids contained within them. Information about the physical properties of rocks and fluids contained within them is used in the oil and gas industry as such properties can impact the location, volume, and recoverability of hydrocarbons within a reservoir. Petrophysics can provide quantitative data that helps describe the reservoir, assess its potential, and ultimately guide optimal extraction techniques.

In petrophysics, various logging tools are used to obtain various measurements of rock and fluid properties. Non-limiting examples of such measurements and tools include gamma ray, resistivity, neutron, density, sonic, nuclear magnetic resonance (NMR), imaging logs, and wireline formation testers. These logs provide measurements of various rock and fluid properties such as porosity, permeability, saturation, fluid type, and/or lithology, among others. However, implementing a comprehensive petrophysical analysis presents a host of challenges. For example, the measurements taken by logging tools are often indirect, which means that there is inherent uncertainty in converting such measurements to meaningful reservoir properties.

Moreover, each logging tool responds differently to different formation conditions and their measurements are often influenced by multiple variables. To better interpret such measurements, a deep understanding of tool physics and the application of empirical or analytical models may be needed. Further, reservoirs themselves are often complex, featuring changes in lithology, fluid content, pressure, and/or temperature that can vary on small scales. The resulting changes in petrophysical properties can increase the difficulty of interpretations. External factors like borehole conditions and mud type can also impact log measurements and may require appropriate corrections. In addition, the high cost of well logging operations and the need for real-time or near-real-time decision-making further increase the pressure to provide accurate interpretations quickly and efficiently.

Further, petrophysics is generally tied to the field from which it is applied. Each field presents a unique set of geological conditions such as different rock types, depositional environments, fluid compositions, structural histories, burial conditions, etc. Such differences can impact how various petrophysical properties are expressed and interpreted in the field. For instance, the same logging response might imply a high porosity sandstone in one field but a low porosity limestone in another, depending on the specifics of the lithology, fluid content, and reservoir condition. Therefore, knowledge of the specific field under study may be necessary for accurate petrophysical interpretation. To this end, petrophysicists can incorporate field-specific knowledge into their interpretation models, making adjustments based on field observations, core analysis, production data, and/or previous well log interpretations.

To navigate these challenges, petrophysicists generally rely on a combination of expert knowledge, practical experience, and advanced analysis techniques. The end goal is to generate a comprehensive and accurate understanding of the reservoir that can support effective decision-making for exploration, drilling, and production activities. Each petrophysical problem can present its own set of challenges, often demanding a deep understanding of the underlying principles, considerable problem-solving skills, and a capacity for advanced reasoning. In many cases, to address a problem, a petrophysicist may need to rely on combination of petrophysical principles and a tailored solution that addresses the specifics of the scenario at hand. As a result, the expertise and experience of a petrophysicist can be very useful when addressing such problems. Indeed, the ability to leverage past knowledge while innovatively applying petrophysical concepts to new challenges can be very important in the petrophysics field. For example, a petrophysicist may need to critically evaluate data from different sources to discern patterns, make connections, and make educated decisions under conditions of uncertainty.

Many machine learning (ML) and artificial intelligence (AI) models, such as large language models (LLMs) have remarkable capabilities in understanding complex knowledge domains, such as petrophysical principles, by being trained on large datasets and implementing a large number of parameters. Such models have the ability to parse and analyze vast amounts of information, draw connections, and provide reasoned responses based on the data they are trained on. Moreover, the models can have a degree of problem-solving skills. Given these abilities, such models can serve as an effective assistant to human petrophysicists. For example, given an LLM's ability to recall petrophysical principles, examine data, and propose solutions based on a wide breadth of knowledge, the LLM can augment the human petrophysicist's capabilities. In some examples, the LLMs can handle routine analysis, propose different solutions, and free the petrophysicist to tackle other, more complex and ambiguous problems that may be better suited for a human perspective.

Despite the potential benefits of leveraging ML/AI models in the petrophysical field, there are significant challenges in implementing such models in the petrophysical field. For example, the complex and often tool-specific nature of petrophysical data interpretation can present a considerable obstacle. Each logging tool produces data that needs to be understood in its unique context, and each field of study has its own set of geological and physical considerations. Moreover, the intricate field-specific knowledge that is often gleaned from years of experience and study is often needed for petrophysical interpretations.

While the versatility of models such as LLMs trained on expansive datasets affords them a broad base of knowledge, such models are not specifically trained as petrophysicists. The models understanding of the field may be derived from a wide array of sources, which may not always reflect the depth and specificity of knowledge possessed by experienced petrophysicists. This lack of focused training can result in gaps in their comprehension and application of complex petrophysical concepts. Therefore, these models could greatly benefit from a more dedicated, integrated experience that revolves around petrophysical principles, tools, and field-specific case studies. Such a targeted approach can simulate the extensive training and hands-on experience that human petrophysicists acquire over the years, thus providing the models with a more nuanced understanding of the field, improving the models' ability to handle specific petrophysical challenges, and increasing the models' potential as an effective petrophysical assistant.

A significant challenge faced during the practical application of petrophysics is that decision-making is often performed in locations where internet connectivity is limited or nonexistent, such as at the wellsite or in remote field operations. Additionally, due to the sensitive nature of oil field data, many operations have stringent security protocols that mandate information be stored on isolated servers or devices, and prohibit cloud-based computing. As such, a model such as an LLM implemented as a petrophysical assistant may need to be configured to run on an edge device (e.g., at the site/field), eliminating the need for internet connection or data transfer to remote systems (e.g., systems located remotely from the site/field). However, the sheer scale of models such as LLMs, which can include a very large number of parameters, presents a significant challenge for deployment of such models on local systems (e.g., edge devices). For example, edge devices may not be equipped with the processing/compute capacity to run an LLM with a large number of parameters that is sufficiently trained with petrophysics and field data.

Described herein are systems, apparatuses, processes (also referred to as methods), and computer-readable media (collectively referred to as “systems and techniques”) for implementing an AI/ML assistant that can be sufficiently trained with petrophysics and field data, and can be implemented at the edge or any other system/device. In some examples, the AI/ML assistant can include an AI/ML model, such as an LLM, configured to direct domain-specific queries to domain-specific models, which can be implemented at the edge (e.g., at the same local device or another local device(s)) and/or at any other system/device. In some aspects, an LLM of the AI/ML assistant can be trained on more general petrophysics and field data/knowledge, and the domain-specific models can be more specifically trained and/or tailored to specific petrophysics and/or field data, topics, concepts, principles, areas, etc. Moreover, the AI/ML assistant can address and overcome the foregoing challenges by reducing the compute footprint/cost of the AI/ML assistant when processing any given query/queries without reducing (or minimally reducing) the overall capacity of the AI/ML assistant relative to other AI/ML models such as other LLMs.

In some examples, to address and overcome the foregoing challenges, the AI/ML assistant can implement an architecture that includes a hierarchical system of domain-specific LLMs that, individually, include less parameters and compute footprint than an LLM trained on multiple petrophysics domains. For example, an LLM with more general petrophysics knowledge and/or training can configured to direct domain-specific queries to domain-specific LLMs that are efficiently compressed to run at edge devices (and/or any other devices) and have a reduced compute footprint, without sacrificing the depth and versatility of their knowledge and/or reasoning capabilities. Such an architecture can enable such an AI/ML assistant to run on an edge device for use on-site, and can enable real-time (or near real-time) petrophysical decision-making.

The AI/ML assistant can be designed and trained in a manner that respects the forgoing complexities and can accommodate for tool-specific and/or field-specific knowledge, thus creating a nuanced, context-aware system capable of delivering valuable insights and enhancing the decision-making process in petrophysics. In some examples, an AI/ML petrophysics assistant can include an LLM configured as a control or management LLM with a larger amount of parameters than the domain-specific LLMs queried by the control or management LLM for specific answers. In some cases, such control or management LLM can be initially trained on a broad/general dataset, and optionally refined and/or re-trained on petrophysics-specific data to increase its domain-specific knowledge and reasoning capabilities. Moreover, the smaller, domain-specific LLMs can be created, configured, and/or tailored for specific petrophysics topics, areas, principles, scenarios, use cases, and/or any other specific aspects. In some examples, such smaller, domain-specific LLMs can be trained on topic-specific data (e.g., tokens) to create specialized models focused on and/or tailored to specific fields, areas, topics, principles, scenarios, and/or knowledge within petrophysics. Non-limiting examples of such domain-specific LLMs can include LLMs trained for and/or tailored to topics, areas, knowledge, fields, scenarios, use cases, and/or principles pertaining to nuclear tools, permeability, resistivity, continuity, lithology, water saturation, pressure, fluid contacts, formation testing, acoustics, electromagnetism, and/or porosity, among others.

The control or management LLM can be configured to act as an interface between a petrophysicist(s) and the specialized LLMs (e.g., the smaller, domain-specific LLMs), intelligently and/or selectively invoking them to assist in converging on a solution to petrophysical queries. With the smaller sizes of the specialized LLMs, such smaller LLMs can efficiently run on edge devices, to be called upon individually by the control or management LLM as needed for task completion. This ensures that a comprehensive and detailed knowledge base is available for real-time petrophysical analysis while reducing the overall compute footprint of the system and adhering to the often stringent requirements of field operation and data security.

In some examples, the control or management LLM and/or any of the specialized LLMs can access a knowledge base of field-specific and any other petrophysical knowledge. In some cases, the knowledge base can function as an evolving repository of analogous results and findings from other (e.g., similar) petrophysical situations encountered in the field. By integrating the information from the knowledge base, the control or management LLM can further refine its proposed solutions to petrophysical queries, enhancing accuracy and reliability. The AI/ML assistant can leverage its inherent reasoning capabilities and accumulated domain-specific knowledge to deliver a comprehensive and highly tuned solution. Such a dual-pronged approach can ensure the adaptability and robustness of the AI/ML assistant, allowing it to learn from previous experiences while efficiently tackling new challenges.

The AI/ML petrophysics assistant can optionally integrate a multi-modal generator model, such as an image-to-text generator model, a video-to-text generator model, a speech-to-text generator model, and/or any other multi-modal model. The multi-modal generator model can allow the transformation of petrophysical graphs, maps, logs, videos, images, charts, and/or other graphical information into textual data that the control or management LLM can process. In this way, even complex visual data can be utilized effectively, ensuring that the nuances of field-specific context are not lost or overlooked. Furthermore, such image-derived information can be used to fine-tune the control or management LLM and the specialized training of the smaller, specialized LLMs. By enabling these models to learn and adapt from graphical data as well as textual data and any other data, the AI/ML assistant's understanding of the petrophysical domains can be enhanced. Moreover, such multifaceted learning approach can empower the LLMs to handle the intricate and diverse challenges of petrophysical interpretation more efficiently and accurately.

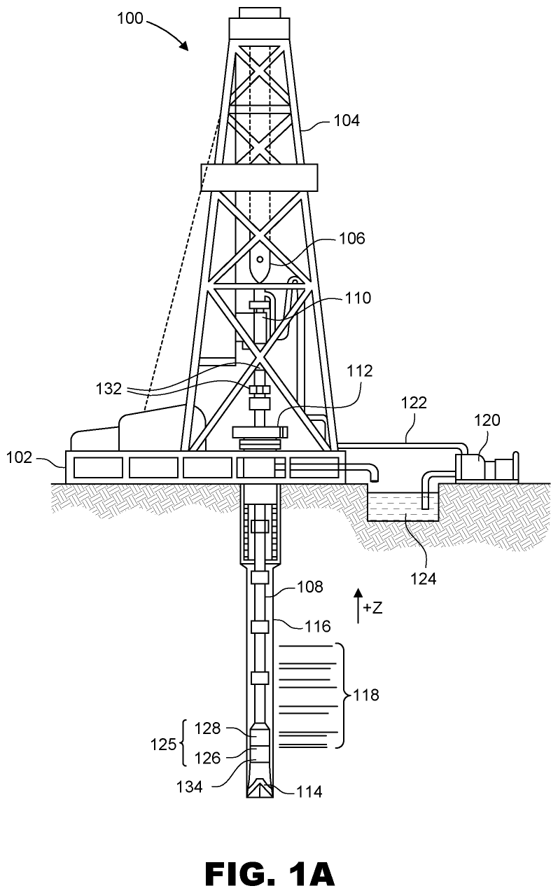

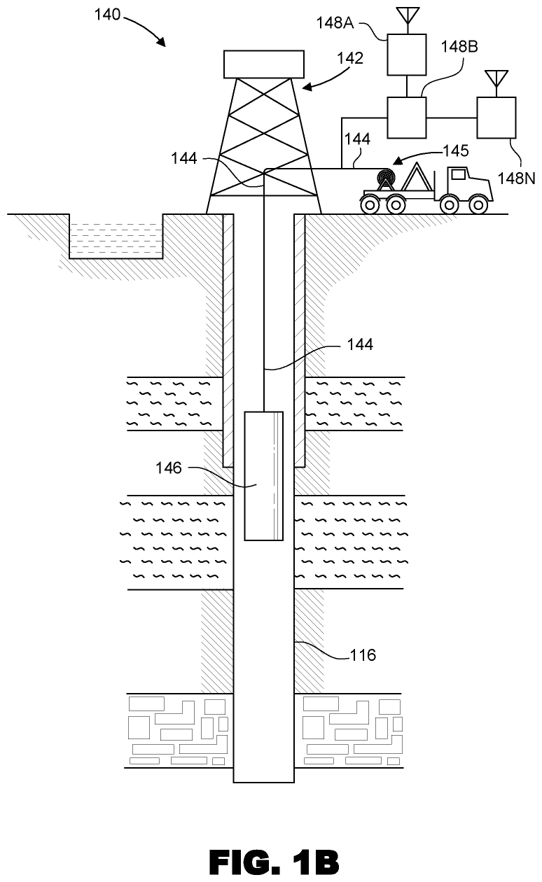

Examples of the systems and techniques described herein are illustrated in FIG. 1A through FIG. 8 and described below.

FIG. 1A is a schematic diagram of an example logging while drilling wellbore operating environment, according to some examples of the present disclosure. The drilling arrangement shown in FIG. 1A provides an example of a logging-while-drilling (commonly abbreviated as LWD) configuration in a wellbore drilling scenario 100. The LWD configuration can incorporate sensors (e.g., EM sensors, seismic sensors, gravity sensor, image sensors, etc.) that can acquire formation data, such as characteristics of the formation, components of the formation, etc. For example, the drilling arrangement shown in FIG. 1A can be used to gather formation data through an electromagnetic imager tool (not shown) as part of logging the wellbore using the electromagnetic imager tool. The drilling arrangement of FIG. 1A also exemplifies what is referred to as Measurement While Drilling (commonly abbreviated as MWD) which utilizes sensors to acquire data from which the wellbore's path and position in three-dimensional space can be determined. FIG. 1A shows a drilling platform 102 equipped with a derrick 104 that supports a hoist 106 for raising and lowering a drill string 108. The hoist 106 suspends a top drive 110 suitable for rotating and lowering the drill string 108 through a well head 112. A drill bit 114 can be connected to the lower end of the drill string 108. As the drill bit 114 rotates, it creates a wellbore 116 that passes through various subterranean formations 118. A pump 120 circulates drilling fluid through a supply pipe 122 to top drive 110, down through the interior of drill string 108 and out orifices in drill bit 114 into the wellbore. The drilling fluid returns to the surface via the annulus around drill string 108, and into a retention pit 124. The drilling fluid transports cuttings from the wellbore 116 into the retention pit 124 and the drilling fluid's presence in the annulus aids in maintaining the integrity of the wellbore 116. Various materials can be used for drilling fluid, including oil-based fluids and water-based fluids.

Logging tools 126 can be integrated into the bottom-hole assembly 125 near the drill bit 114. As drill bit 114 extends into the wellbore 116 through the formations 118 and as the drill string 108 is pulled out of the wellbore 116, logging tools 126 collect measurements relating to various formation properties as well as the orientation of the tool and various other drilling conditions. The logging tool 126 can be applicable tools for collecting measurements in a drilling scenario, such as the electromagnetic imager tools described herein. Each of the logging tools 126 may include one or more tool components spaced apart from each other and communicatively coupled by one or more wires and/or other communication arrangement. The logging tools 126 may also include one or more computing devices communicatively coupled with one or more of the tool components. The one or more computing devices may be configured to control or monitor a performance of the tool, process logging data, and/or carry out one or more aspects of the methods and processes of the present disclosure.

The bottom-hole assembly 125 may also include a telemetry sub 128 to transfer measurement data to a surface receiver 132 and to receive commands from the surface. In at least some cases, the telemetry sub 128 communicates with a surface receiver 132 by wireless signal transmission (e.g., using mud pulse telemetry, EM telemetry, or acoustic telemetry). In other cases, one or more of the logging tools 126 may communicate with a surface receiver 132 by a wire, such as wired drill pipe. In some instances, the telemetry sub 128 does not communicate with the surface, but rather stores logging data for later retrieval at the surface when the logging assembly is recovered. In at least some cases, one or more of the logging tools 126 may receive electrical power from a wire that extends to the surface, including wires extending through a wired drill pipe. In other cases, power is provided from one or more batteries or via power generated downhole.

Collar 134 is a frequent component of a drill string 108 and generally resembles a very thick-walled cylindrical pipe, typically with threaded ends and a hollow core for the conveyance of drilling fluid. Multiple collars 134 can be included in the drill string 108 and are constructed and intended to be heavy to apply weight on the drill bit 114 to assist the drilling process. Because of the thickness of the collar's wall, pocket-type cutouts or other type recesses can be provided into the collar's wall without negatively impacting the integrity (strength, rigidity and the like) of the collar as a component of the drill string 108.

FIG. 1B is a schematic diagram of an example downhole environment having tubulars, according to some examples of the present disclosure. In this example, an example system 140 is depicted for conducting downhole measurements after at least a portion of a wellbore has been drilled and the drill string removed from the well. An electromagnetic imager tool (not shown) can be operated in the example system 140 shown in FIG. 1B to log the wellbore. A downhole tool is shown having a tool body 146 in order to carry out logging and/or other operations. For example, instead of using the drill string 108 of FIG. 1A to lower the downhole tool, which can contain sensors and/or other instrumentation for detecting and logging nearby characteristics and conditions of the wellbore 116 and surrounding formations, a wireline conveyance 144 can be used. The tool body 146 can be lowered into the wellbore 116 by wireline conveyance 144. The wireline conveyance 144 can be anchored in the drill rig 142 or by a portable means such as a truck 145. The wireline conveyance 144 can include one or more wires, slicklines, cables, and/or the like, as well as tubular conveyances such as coiled tubing, joint tubing, or other tubulars. The downhole tool can include an applicable tool for collecting measurements in a drilling scenario, such as the electromagnetic imager tools described herein.

The illustrated wireline conveyance 144 provides power and support for the tool, as well as enabling communication between data processors 148A-N on the surface. In some examples, the wireline conveyance 144 can include electrical and/or fiber optic cabling for carrying out communications. The wireline conveyance 144 is sufficiently strong and flexible to tether the tool body 146 through the wellbore 116, while also permitting communication through the wireline conveyance 144 to one or more of the processors 148A-N, which can include local and/or remote processors. The processors 148A-N can be integrated as part of an applicable computing system, such as the computing device architectures described herein. Moreover, power can be supplied via the wireline conveyance 144 to meet power requirements of the tool. For slickline or coiled tubing configurations, power can be supplied downhole with a battery or via a downhole generator.

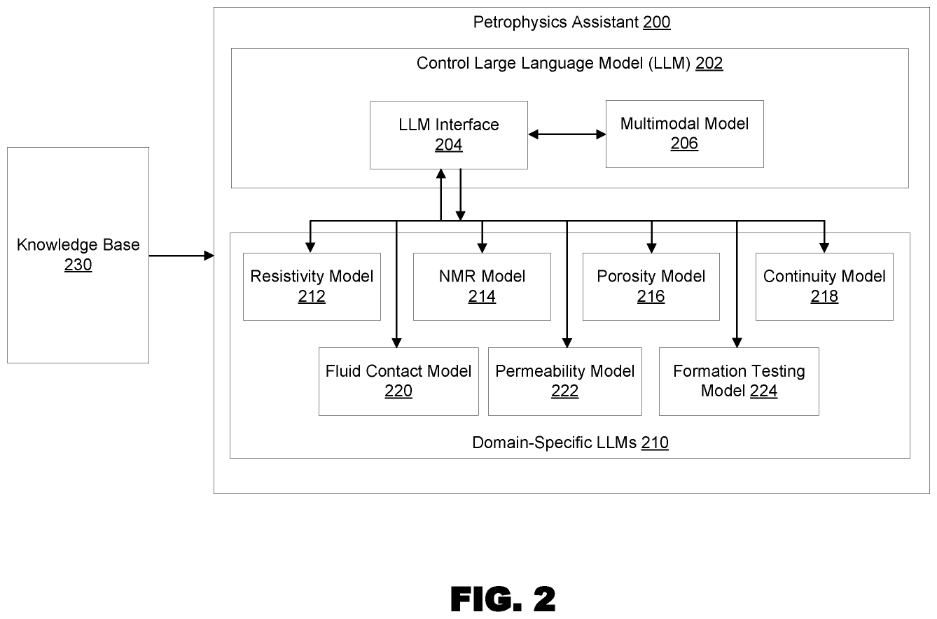

FIG. 2 is a diagram illustrating an example architecture of an example petrophysics assistant 200, according to some examples of the present disclosure. The petrophysics assistant 200 can be used by any user, such as a petrophysicist(s), to obtain information such as answers to questions relating to various petrophysics issues, problems, properties, conditions, areas, topics, scenarios, fields, measurements, contexts, and/or any other aspects. The petrophysics assistant 200 can be configured to provide general and/or specific petrophysics and field information/knowledge. The petrophysics assistant 200 can have a high overall capacity with a reduced compute footprint that can allow the petrophysics assistant 200 to run on devices with less resources/capabilities than servers or datacenters, such as edge and client devices.

The petrophysics assistant 200 can include a control LLM 202 and a number of domain-specific LLMs 210. The domain-specific LLMs 210 can include LLMs that are specialized (e.g., tailored, specifically trained, tuned, etc.) for specific petrophysics areas, topics, fields, scenarios, conditions, use cases, principles, subjects, contexts, and/or any other aspects. For instance, in the example shown in FIG. 2, the domain-specific LLMs 210 can include a resistivity model 212 trained and tailored to (e.g., specialized for, tuned for, etc.) provide and/or include resistivity knowledge and/or reasoning capabilities, a nuclear magnetic resonance (NMR) model 214 trained and tailored to provide and/or include NMR knowledge and/or reasoning capabilities, a porosity model 216 trained and tailored to provide and/or include porosity knowledge and/or reasoning capabilities, a continuity model 218 trained and tailored to provide and/or include continuity knowledge and/or reasoning capabilities, a fluid contact model 220 trained and tailored to provide and/or include fluid contact knowledge and/or reasoning capabilities, a permeability model 222 trained and tailored to provide and/or include permeability knowledge and/or reasoning capabilities, and a formation testing model 224 trained and tailored to provide and/or include formation testing knowledge and/or reasoning capabilities. The domain-specific LLMs 210 in FIG. 2 are merely illustrative examples provided for explanation purposes. In other examples, the domain-specific LLMs 210 can include other models that are not shown in FIG. 2 and/or a different number of models than shown in FIG. 2.

Each of the domain-specific LLMs 210 can be trained using one or more sources of knowledge pertaining to a respective petrophysics domain (e.g., topic, area, field, subject, use case, scenario, condition, principle, context, concept, etc.), such as one or more journal articles, scientific papers, field reports, question-answer pairs, petrophysics and/or wellbore logs, tool-specific data, field-specific data, training sessions/materials, tutorials, books, manuals, tool data, gathering and processing data, visual data (e.g., graphs, charts, maps, images, videos, logs, etc.), publications, textbooks, internal knowledge materials, historical data, statistics, database knowledge, notes, research data, messages and/or observations from petrophysicists and/or other users such as other scientists, drilling reports, and/or any other petrophysics data and/or knowledge materials. This way, each of the domain-specific LLMs 210 can develop an expertise in a respective petrophysics domain, which can allow each of the domain-specific LLMs 210 to answer queries pertaining to its respective petrophysics domain/expertise.

The control LLM 202 can include an LLM configured to direct domain-specific queries to specific LLMs from the domain-specific LLMs 210. This can allow the petrophysics assistant 200 to reduce its compute footprint when processing/answering any given query without reducing the overall amount of petrophysics and field knowledge and reasoning capabilities. For example, a given petrophysics query may best be addressed by one or more of the domain-specific LLMs 210, in which case it may be unnecessary and/or wasteful (e.g., in terms of resources) to direct the petrophysics query to all of the domain-specific LLMs 210, direct the petrophysics query to a subset of the domain-specific LLMs 210 that includes one or more domain-specific LLMs that may be less suited to answer the petrophysics query, or to use a single LLM with the overall size and capabilities of all of the domain-specific LLMs 210 to answer any given petrophysics query. Thus, rather than directing a given query to all of the domain-specific LLMs 210 or to a single LLM that includes the overall parameters, knowledge, size, and/or reasoning capabilities of all of the domain-specific LLMs 210, the control LLM 202 can intelligently determine which LLM(s) from the domain-specific LLMs 210 may be best suited to answer the given query and selectively direct the given query to such LLM(s) for processing/answering.

In the above example, since each individual LLM from the domain-specific LLMs 210 is smaller (e.g., in terms of parameters, overall size, etc.) and has a smaller computer footprint than all of the domain-specific LLMs 210 or than a single LLM with the parameters, size, knowledge, and/or capabilities of all of the domain-specific LLMs 210, by intelligently directing queries to specific LLMs from the domain-specific LLMs 210 (e.g., rather than directing each query to all of the domain-specific LLMs 210 or to an LLM with the size, parameters, knowledge, and/or capabilities of all of the domain-specific LLMs 210), the control LLM 202 can reduce the amount of resources (e.g., compute footprint, etc.) used by the petrophysics assistant 200 to process/answer any given query, which can in turn allow the petrophysics assistant 200 to run on devices with less resources and/or capabilities, such as client/edge devices, tools, etc. This way, the petrophysics assistant 200 can be implemented on any device and used by any user (e.g., petrophysicist) in any field or environment, including fields or environments where Internet and/or remote data access is/are not available or permitted.

The control LLM 202 can be trained on more general petrophysics and field data/knowledge than the domain-specific LLMs 210, in order to obtain a more general and/or broad understanding of petrophysics. For example, in some cases, the control LLM 202 can be trained using one or more sources of petrophysics and/or field knowledge such as, for example, one or more journal articles, scientific papers, field reports, question-answer pairs, petrophysics and/or wellbore logs, tool-specific data, field-specific data, training sessions/materials, tutorials, books, manuals, tool data, gathering and processing data, visual data (e.g., graphs, charts, maps, images, videos, logs, etc.), publications, textbooks, internal knowledge materials, historical data, statistics, database knowledge, notes, research data, messages and/or observations from petrophysicists and/or other users such as other scientists, drilling reports, and/or any other petrophysics data and/or knowledge materials. In some cases, the control LLM 202 can be initially trained on a broad/general dataset, and optionally refined and/or re-trained on petrophysics-specific data to increase its domain-specific knowledge and reasoning capabilities.

For example, in some cases, the control LLM 202 can be trained using one or more knowledge/data sources to generally understand each domain of the domain-specific LLMs 210, what questions may relate to each domain, what questions may be answered by (or may best be answered by) each of the domain-specific LLMs 210, any patterns that fit a question that any of the domain-specific LLMs 210 may answer, any information (e.g., issues, attributes, conditions, principles, parameters, problems, topics, concepts, etc.) that may relate to the domains (and/or associated questions) associated with the domain-specific LLMs 210, what model(s) from the domain-specific LLMs 210 may best understand a question and/or provide a most accurate and/or relevant response to the question, and/or otherwise how to intelligently select which model(s) from the domain-specific LLMs 210 to direct any given query to. To illustrate, the control LLM 202 can be trained to understand that a particular question relating to the porosity of a particular formation may best be answered by, for example, the resistivity model 212, the NMR model 214, the porosity model 216, and the formation testing model 224. The control LLM 202 can then select the resistivity model 212, the NMR model 214, the porosity model 216, and the formation testing model 224 to answer such query and direct the query to the resistivity model 212, the NMR model 214, the porosity model 216, and the formation testing model 224.

As an example and by way of analogy, the control LLM 202 can function similar to a primary care physician that has general medical expertise, and the domain-specific LLMs 210 can function similar to specialized physicians with specialized expertise in one or more particular areas of medicine. In such example analogy, a primary care physician can examine a patient for a particular condition and determine which specialized physician(s) may be best suited to assist with the particular condition. The primary care physician can then direct the patient to the specialized physician(s) for help with the particular condition (and/or consult with the specialized physician(s) about the patient and the particular condition). Similarly, when the control LLM 202 receives a petrophysical query, the control LLM 202 can determine which model(s) from the domain-specific LLMs 210 is/are best suited to answer the petrophysical query, and direct the petrophysical query to such model(s). The control LLM 202 can use any responses from such model(s) to provide a response to the query, as further described herein.

In some examples, the control LLM 202 can include an LLM interface 204 and a multimodal model 206. The LLM interface 204 can include any software, interface, and/or component configured to act as an interface between a user(s) (e.g., a petrophysicist(s), a technician(s), an engineer(s), etc.) and the domain-specific LLMs 210. For example, a user can access the petrophysics assistant 200 via the LLM interface 204 and use the LLM interface 204 to submit one or more petrophysics queries and receive one or more responses from the petrophysics assistant 200. The LLM interface 204 can communicate with any of the domain-specific LLMs 210 to provide queries to and receive responses from any of the domain-specific LLMs 210. For example, the LLM interface 204 can receive a given query from a user. The control LLM 202 can intelligently determine which LLM(s) from the domain-specific LLMs 210 can answer the query (and/or is/are best suited to answer the query). The LLM interface 204 can then selectively invoke/call the determined LLM(s) from the domain-specific LLMs 210 to obtain a respective response to the query. The LLM interface 204 can obtain the respective response to the query from each LLM queried. The LLM interface 204 can then provide (e.g., display/present, render, etc.) a response to the user.

In some cases, before providing the response to the user, the control LLM 202 can edit the information obtained from each queried LLM. For example, the control LLM 202 can coalesce, converge, distill, paraphrase/summarize, supplement, enhance, organize, structure, utilize, and/or otherwise revise any of the information obtained from each queried LLM to generate a response to the user, which can be provided to the user by the LLM interface 204. For example, if the control LLM 202 receives one or more query responses from one or more of the domain-specific LLMs 210, the control LLM 202 can use the one or more query responses to generate a response to the query. In this example, the control LLM 202 can combine the one or more query responses or portions thereof to generate a meaningful response, and can optionally use its broader, more general petrophysics knowledge to create the response based on the one or more query responses, make any changes to the response, add any relevant, details, refine the dialogue including the response to the user, and/or otherwise edit or formulate the response to the user.

To illustrate, if the query includes a question about a porosity associated with a specific formation, the control LLM 202 may determine that the resistivity model 212, the NMR model 214, the porosity model 216, and the formation testing model 224 are best suited to answer the query, and select such models to answer the query. The LLM interface 204 can provide the query to the resistivity model 212, the NMR model 214, the porosity model 216, and the formation testing model 224, and receive a respective response from each model. The control LLM 202 can use the responses from the resistivity model 212, the NMR model 214, the porosity model 216, and the formation testing model 224 to formulate a response for the user. For example, the control LLM 202 can coalesce the responses (or portions thereof) from the resistivity model 212, the NMR model 214, the porosity model 216, and the formation testing model 224 in an intelligent/meaningful, organized, and/or structured manner using the petrophysics knowledge and capabilities of the control LLM 202. In some cases, the control LLM 202 can use its petrophysics knowledge and capabilities to refine or reformulate the response generated based on the responses from the resistivity model 212, the NMR model 214, the porosity model 216, and the formation testing model 224, and/or add any relevant information determined by the control LLM 202 based on the knowledge and capabilities of the control LLM 202.

In some examples, when responding to one or more user queries, the control LLM 202 can generate dialogue that can include any query responses, request additional information from the user, refine a dialogue between the user and the petrophysics assistant 200, and/or convey and/or request any other relevant information. For example, if the control LLM 202 determines that a query from a user is too broad or vague to provide a meaningful response to the user, the control LLM 202 can request additional information from the user to refine the query and generate a more meaningful response. As another example, if the control LLM 202 determines that a query response(s) from a model(s) of the domain-specific LLMs 210 is too generic (e.g., lacks a threshold amount/level of specificity and/or relevance) and/or too long, the control LLM 202 can try to reduce or refine the query response(s) or request additional information from the user to refine the query and use the refined query to provide a more specific and/or shorter response. In some cases, the control LLM 202 can include one or more parameters defining any restrictions that the control LLM 202 can use to determine if a query and/or query response should be refined. For example, if a query is too broad, the query response obtained by the control LLM 202 may be too generic and/or long. To determine that the query is too broad and/or the query response is too generic and/or long, the control LLM 202 can include parameters defining a response size limit, a query size limit, a minimum query size, a response specificity, a query specificity, and/or any other parameters that the control LLM 202 can use to determine whether a query and/or query response needs to be expanded, reduced, and/or refined.

As previously noted, the control LLM 202 can include a multimodal model 206, such as an image-to-text generator model, a video-to-text generator model, a speech-to-text generator model, and/or any other multimodal generator model. The multimodal model 206 can allow the petrophysics assistant 200 to transform input data from one mode to another mode and/or output data from one mode to another mode. For example, the multimodal model 206 can transform image data (e.g., an image, a video, etc.) provided by the user to text data that the petrophysics assistant 200 can use to understand a query and/or formulate a response. To illustrate, as part of a query (and/or as part of information provided with a query), a user can provide (e.g., via the LLM interface 204) image data to the petrophysics assistant 200, such as one or more petrophysical graphs, maps, logs, charts, and/or other graphical information. The multimodal model 206 can transform such image data into textual data and provide the text data to the control LLM 202. The control LLM 202 can use the text data to understand the query, formulate/reformulate the query, and/or provide a query response. In this way, even complex visual data can be utilized effectively, ensuring that the nuances of field-specific context are not lost or overlooked.

As another example, a user can provide (e.g., via the LLM interface 204) a visual petrophysical log to the petrophysics assistant 200 with a question about a portion of the visual petrophysical log. The multimodal model 206 can scan the visual petrophysical log and convert the visual petrophysical log (or the relevant portion of the visual petrophysical log) into text (e.g., via image-to-text conversion) providing information (e.g., a description, a translation, a summary, details, etc.) about the visual petrophysical log (or the relevant portion of the visual petrophysical log), such as descriptors of the visual petrophysical log (or the relevant portion of the visual petrophysical log). The multimodal model 206 can provide the text generated from the image data to the control LLM 202, which can use to include with the query, formulate the query, supplement the information in the query, provide additional context for the query, help determine which model(s) from the domain-specific LLMs 210 to direct the query to, and/or provide information relevant to the query that a model(s) from the domain-specific LLMs 210 selected to answer the query can use to understand the query and/or provide a query response.

As yet another example, the multimodal model 206 can transform audio received with an input query, such as speech or acoustic data, into text describing the audio and/or providing information about the audio. The multimodal model 206 can provide the text generated from the audio to the control LLM 202, which can use the generated text and any other information in the query to understand the query, formulate/reformulate the query, supplement the query, provide additional context, help determine which model(s) from the domain-specific LLMs 210 to direct the query to, and/or provide information relevant to the query that a model(s) selected from the domain-specific LLMs 210 can use to answer the query.

The multimodal model 206 can be trained using petrophysics data of a particular format/type, such as an input mode. For example, to train the multimodal model 206 to convert visual petrophysics data (e.g., images and/or videos such as visual logs, charts, maps, etc.) into text describing such visual petrophysics data, the multimodal model 206 can be trained with a dataset of visual petrophysics data. In some cases, the training dataset (e.g., the dataset of visual petrophysics data) can include domain-specific petrophysics data, general petrophysics data, field data, and/or any other petrophysics data and/or field data.

In some aspects, the text information derived by the multimodal model 206 from other type of data (e.g., image data, audio data, etc.) can be used to fine-tune the control LLM 202 and/or the domain-specific LLMs 210. By enabling the models to learn and adapt from different types/modes of data, the understanding of the petrophysical domains by the petrophysics assistant 200 can be enhanced.

In some examples, the control LLM 202, the LLM interface 204, and/or the multimodal model 206 can be part of the same model. For example, the control LLM 202, the LLM interface 204, and/or the multimodal model 206 can be implemented by a same model. As another example, the control LLM 202 can include a core model and the LLM interface 204 and/or the multimodal model 206 can include one or more model heads or branches. In other examples, the control LLM 202, the LLM interface 204, and/or the multimodal model 206 can be part of different models. For example, the control LLM 202 can be a different model than a model(s) implementing the LLM interface 204 and/or the multimodal model 206.

In some examples, the control LLM 202 and/or any of the domain-specific LLMs 210 can access a knowledge base 230 of information for use in understanding a query and/or formulating a query response. For example, when a model from the domain-specific LLMs 210 receives a query, the model can perform a semantic search of relevant data in the knowledge base 230 to identify the best and/or more relevant information in the knowledge base 230 for use in formulating a response to the query. Similarly, the control LLM 202 can access the knowledge base 230 to understand a query and/or obtain information that the control LLM 202 can use along with any query responses from any of the domain-specific LLMs 210 to formulate/reformulate a query response for the user and/or supplement, revise, and/or coalesce one or more query responses from one or more of the domain-specific LLMs 210. In some cases, the meaning of content (e.g., sentences, words, etc.) in the knowledge base 230 can be encoded into encoded or structured data (e.g., vectors encoding the meaning of content such as sentences, etc.) that can be used to find information during a semantic search of the knowledge base 230.

For example, when a model (e.g., the control LLM 202 and/or any of the domain-specific LLMs 210) receives a query, the model can encode the query into an encoded query (e.g., a vector, and/or structured data encoding the query and/or the meaning of the query, etc.) and used to search encoded data in the knowledge base 230 to find a semantic search result. In some cases, the model can encode the query into a vector that encodes the semantic meaning of the query and use the encoded vector to identify one or more encoded vectors in the knowledge base 230, which encode the semantic meaning of content in the knowledge base 230 such as sentences, that best match the encoded query. The one or more encoded vectors that best match the encoded query can include, for example and without limitation, the encoded vector from the knowledge base 230 determined to be the best/highest match for the encoded query, the top n number of best/highest matching encoded vectors from the knowledge base 230, the encoded vector(s) from the knowledge base 230 having at least a threshold match with the encoded query, or any other number of encoded vectors.

In some cases, a model (e.g., the control LLM 202 and/or any of the domain-specific LLMs 210) can use the knowledge base 230 for lookups and the learned capabilities of the model (e.g., learned knowledge, learned reasoning capabilities, learned semantic understanding capabilities, learned pattern recognition capabilities, etc.) to digest, analyze, understand, interpret, verify, organize, filter, rank, and/or identify relevant information in the knowledge base 230.

The knowledge base 230 can include any petrophysical information such as, for example and without limitation, field-specific knowledge, tool-specific knowledge, context-specific knowledge, general and/or domain-specific petrophysical knowledge, and/or any other petrophysical information. In some examples, the knowledge base 230 can include a repository of information (e.g., a database(s), a data store(s), a library, a dataset, a set of documents, etc.) such as, for example and without limitation, one or more journal articles, scientific papers, field reports, question-answer pairs, petrophysics and/or wellbore logs, tool-specific data, field-specific data, training sessions/materials, tutorials, books, manuals, tool data, gathering and processing data, drilling reports, visual data (e.g., graphs, charts, maps, images, videos, logs, etc.), publications, textbooks, internal knowledge materials, historical data, statistics, database knowledge, notes, recordings, research data, user messages and/or observations, and/or any other petrophysics data and/or knowledge materials.

In some cases, the knowledge base 230 can include analogous results and/or findings from one or more (e.g., similar, different, related, etc.) petrophysical situations, questions, contexts, conditions, and/or events encountered in the field. With the information from the knowledge base 230, the control LLM 202 can refine its responses to petrophysical queries, enhancing accuracy and reliability. The knowledge base 230 can also be updated as desired to include or remove certain information. For example, the knowledge base 230 can be updated with additional materials, field results, findings, information, and/or relevant information as needed or desired.

As described above, the petrophysics assistant 200 can have and/or provide general knowledge, petrophysics-specific knowledge, tool-specific knowledge, field-specific knowledge, and/or any other relevant knowledge. Moreover, the petrophysics assistant 200 can include natural language processing capabilities, multimodal processing capabilities (e.g., visual data processing capabilities, audio data processing capabilities, etc.), reasoning capabilities, learning capabilities, response/data compilation and/or formulation capabilities (e.g., capabilities for compiling knowledge responses, etc.), and/or any other capabilities. The petrophysics assistant 200 can provide feedback on a job status, answer specific questions, provide consultations and/or suggestions to users, make decisions, identify issues, provide information to assist one or more users to manage a wellbore environment and/or wellbore operations, and/or provide any other assistance to users relating to petrophysics, wellbores/fields, associated tools, and/or any other knowledge.

For example, a user, such as a scientist or engineer working at a wellsite, can use the petrophysics assistant 200 as an AI tool to obtain feedback about a task or job, ask questions about a wellsite (e.g., associated conditions, formation properties, events, petrophysical matters, petrophysical measurements, findings/results, analysis, etc.), ask questions about a job or task at a wellsite, ask questions regarding a context (e.g., a field context, a tool context, a use case, a situation, etc.), make decisions, identify issues, obtain relevant information, make consultations, receive suggestions, etc. To illustrate, if a user has a question about a petrophysical measurement, finding, condition, etc., the user can submit the question to the petrophysics assistant 200. The control LLM 202 of the petrophysics assistant 200 can determine a subset of domain-specific LLMs from the domain-specific LLMs 210 to direct the question to, and send a call, command, instruction, and/or message to the determined subset of domain-specific LLMs that triggers the subset of domain-specific LLMs to run/execute to generate one or more respective responses to the question. The subset of domain-specific LLMs can then provide the one or more respective responses to the control LLM 202, which can use the one or more respective responses to formulate a response to the query for the user. The control LLM 202 can then provide the formulated response to the user via the LLM interface 204. The control LLM 202 can generate dialogue for the user to provide the formulated response, ask follow-up questions, request additional information, receive additional or follow-up questions from the user, provide further assistance to the user, etc., as further described herein.

The petrophysics assistant 200 can run on any computing device, such as a server, a tool with computing capabilities, a client device, and/or any other computing and/or edge device. For example, the petrophysics assistant 200 can be compressed to run on edge devices that have less compute resources (e.g., more compute resource constraints) than higher-end devices such as servers. Moreover, the control LLM 202 and/or any of the domain-specific LLMs 210 can be trained using data generated and/or compiled by a human and/or data generated and/or compiled by a model.

For example, in some cases, the control LLM 202 and/or any of the domain-specific LLMs 210 can be trained using question-answer pairs generated and/or compiled by a human and/or a model. In some examples, an LLM can be used to generate question-answer pairs that can be used to train the control LLM 202 and/or any of the domain-specific LLMs 210 (e.g., with or without any question-answer pairs generated/compiled by a human).

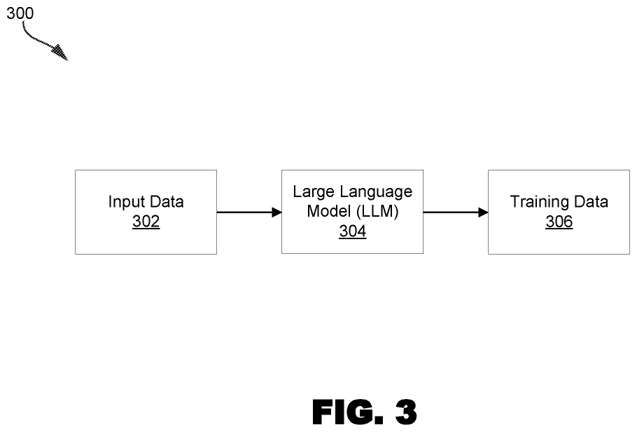

FIG. 3 is a diagram illustrating an example system 300 for generating training data used to train the control LLM 202 and/or any of the domain-specific LLMs 210, according to some examples of the present disclosure. In this example, an LLM 304 can be used to generate training data 306 used to train the control LLM 202 and/or any of the domain-specific LLMs 210. The LLM 304 can generate the training data 306 based on input data 302 that includes relevant knowledge/information.

In some cases, the input data 302 can include, for example and without limitation, one or more journal articles, scientific papers, field reports, question-answer pairs, petrophysics and/or wellbore logs, tool-specific data, field-specific data, training sessions/materials, tutorials, books, manuals, tool data, gathering and processing data, drilling reports, publications, textbooks, internal knowledge materials, historical data, statistics, database knowledge, notes, recordings, research data, user messages and/or observations, and/or any other petrophysics data and/or knowledge materials. Moreover, the training data 306 can include any relevant structured knowledge/information. For example, in some cases, the training data 306 can include question-answer pairs generated from the input data 302.

In some examples, the data used to generate the input data 302 can be classified into associated subject areas, topics, scenarios, use cases, and/or any other class. For example, to generate the input data 302, a set of petrophysics data (e.g., papers, books, manuals, documents, etc.) and/or portions thereof can be classified (e.g., by the LLM 304 or another model) into subject areas. Each item can be classified into one or more relevant subject areas. For example, a petrophysics paper can be classified into a single subject area or, in some cases where the petrophysics paper relates to multiple subject areas, into multiple subject areas. The input data 302 can thus include data classified into various buckets of subject areas. The LLM 304 can process such input data 302 to generate the training data 306. For example, the LLM 304 can process data in each classification bucket to generate question-answer pairs related to that classification bucket (e.g., related to the subject area associated with that classification bucket). In this example, the question-answer pairs in the training data 306 can then be used to train the control LLM 202 and/or any of the domain-specific LLMs 210. For example, question-answer pairs from a classification bucket related to a specific domain can be used to train a domain-specific LLM associated with the specific domain (and, in some cases, the control LLM 202). To illustrate, question-answer pairs from a classification bucket related to resistivity can be used to train the resistivity model 212 while question-answer pairs from a classification bucket related to NMR can be used to train the NMR model 214.

In some cases, the control LLM 202 can be trained using general and/or domain-specific question-answer pairs in the training data 306. For example, the control LLM 202 can be trained using question-answer pairs from a classification bucket related to a general petrophysics knowledge. In some cases, the control LLM 202 can additionally or alternatively be trained using question-answer pairs from one or more classification buckets related to one or more subject areas.

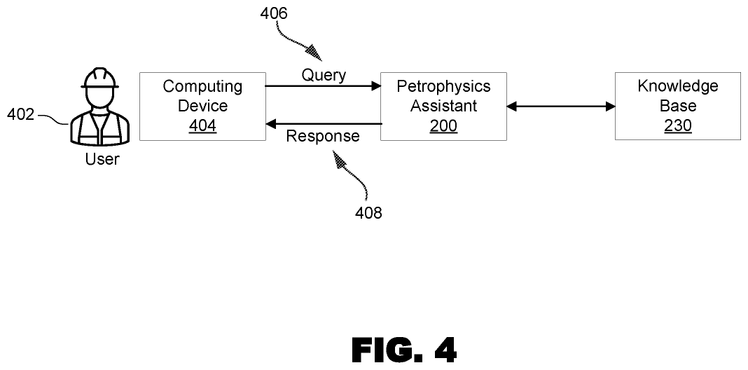

FIG. 4 is a diagram illustrating an example use of the petrophysics assistant 200, according to some examples of the present disclosure. As shown, a user 402 (e.g., a petrophysicist, engineer, technician, agent, etc.) can access the petrophysics assistant 200 from a computing device 404. The computing device 404 can include any computing device capable of running a model such as, for example and without limitation, a server, an edge device (e.g., a laptop computer, a desktop computer, a tablet computer, a tool with computing capabilities, etc.), or any other computing device.

The user 402 can use the computing device 404 to submit a query 406 to the petrophysics assistant 200, which the petrophysics assistant 200 can use to generate a response 408 for the user 402. In some cases, when generating the response 408, the petrophysics assistant 200 can perform one or more look-ups in the knowledge base 230, as previously described. Moreover, in some examples, the petrophysics assistant 200 can generate dialogue with the user 402. For example, the petrophysics assistant 200 can receive the query 406, provide the response 408, receive a follow-up query (and/or request additional information), provide a follow-up response, etc.

To illustrate, assume that the query 406 can include the question “Why is the neutron porosity different than NMR porosity?”. The petrophysics assistant 200 can receive the query 406 and generate a response 408, such as “Neutron porosity is affected by lithology and specific fluid properties. NMR porosity is affected by lithology, laminations and logging speed. I see that for conductive fluids with low gamma ray which is brine in a siliciclastic formation, the neutron porosity is sharper than the NMR porosity. This implies that logging speed may be the issue for NMR porosity. Perhaps try slowing down the NMR logging speed.” The petrophysics assistant 200 can provide such response 408 for the user 402. In some cases, the user 402 may want to submit a follow-up query such as, for example, “Okay, the re-log at a slower speed matches much better, but the permeability looks high for this field. What do you think?” The petrophysics assistant 200 can similarly generate a response to the follow-up query and in this way engage in dialogue with the user 402 via the computing device 404.

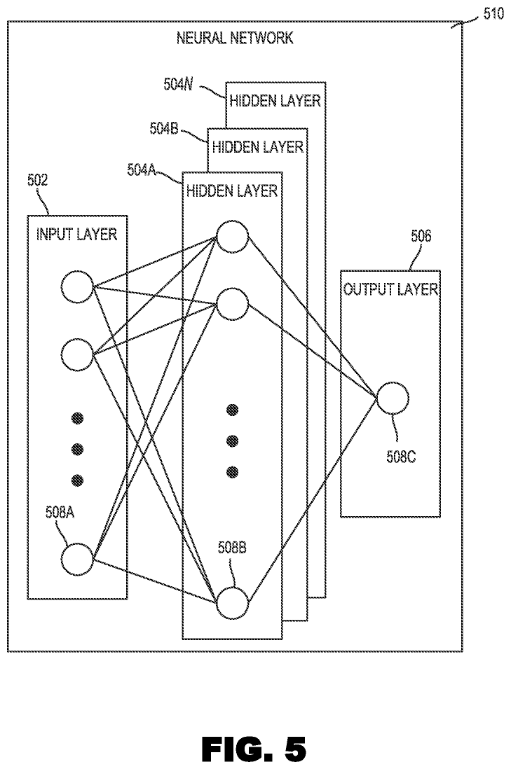

FIG. 5 illustrates an example of a neural network 510 according to some examples of the present disclosure. The neural network 510 can be used to implement any of the models described herein, such as the control LLM 202, the multimodal model 206, any of the domain-specific LLMs 210, the LLM 304, etc. As shown in this example, the neural network 510 includes an input layer 502 for processing input data. The neural network 510 also includes hidden layers 504A through 504N (collectively “504” hereinafter). The hidden layers 504 can include n number of hidden layers, where n is an integer greater than or equal to one. The number of hidden layers can include as many layers as needed for a desired processing outcome and/or rendering intent. The neural network 510 includes an output layer 506 that provides an output resulting from the processing performed by the hidden layers 504.

The neural network 510 in this example is a multi-layer neural network of interconnected nodes. Each node can represent a piece of information. Information associated with the nodes is shared among the different layers and each layer retains information as information is processed. In some cases, the neural network 510 can include a feed-forward neural network, in which case there are no feedback connections where outputs of the neural network are fed back into itself. In other cases, the neural network 510 can include a recurrent neural network, which can have loops that allow information to be carried across nodes while reading in input.

Information can be exchanged between nodes through node-to-node interconnections between the various layers. Nodes of the input layer 502 can activate a set of nodes in the first hidden layer 504A. For example, as shown, each of the input nodes of the input layer 502 is connected to each of the nodes of the first hidden layer 504A. The nodes of the hidden layer 504A can transform the information of each input node by applying activation functions to the information. The information derived from the transformation can then be passed to and can activate the nodes of the next hidden layer (e.g., 504B), which can perform their own designated functions. Example functions include convolutional, up-sampling, data transformation, pooling, and/or any other suitable functions. The output of the hidden layer (e.g., 504B) can then activate nodes of the next hidden layer (e.g., 504N), and so on. The output of the last hidden layer can activate one or more nodes of the output layer 506, at which point an output is provided. In some cases, while nodes (e.g., nodes 508A, 508B, 508C) in the neural network 510 are shown as having multiple output lines, a node has a single output and all lines shown as being output from a node represent the same output value.

In some cases, each node or interconnection between nodes can have a weight that is a set of parameters derived from training the neural network 510. For example, an interconnection between nodes can represent a piece of information learned about the interconnected nodes. The interconnection can have a numeric weight that can be tuned (e.g., based on a training dataset), allowing the neural network 510 to be adaptive to inputs and able to learn as more data is processed.

The neural network 510 can be pre-trained to process the features from the data in the input layer 502 using the different hidden layers 504 in order to provide the output through the output layer 506. In an example in which the neural network 510 is used to output text answers, the neural network 510 can be trained using training data that includes example question-answer pairs.

In some cases, the neural network 510 can adjust weights of nodes using a training process called backpropagation. Backpropagation can include a forward pass, a loss function, a backward pass, and a weight update. The forward pass, loss function, backward pass, and parameter update is performed for one training iteration. The process can be repeated for a certain number of iterations for each set of training media data until the weights of the layers are accurately tuned.

For example, the forward pass can include passing training data through the neural network 510. The weights can be initially randomized before the neural network 510 is trained. For a first training iteration for the neural network 510, the output can include values that do not give preference to any particular class due to the weights being randomly selected at initialization. For example, if the output is a vector with probabilities for different outputs, the probability value for each of the different outputs may be equal or at least very similar (e.g., for ten possible outputs, each output may have a probability value of 0.1). With the initial weights, the neural network 510 may be unable to determine low level features and thus may not make an accurate determination. A loss function can be used to analyze errors in the output. Any suitable loss function definition can be used.

The loss (or error) can be high for the first training dataset (e.g., images) since the actual values will be different than the predicted output. The goal of training is to minimize the amount of loss so that the predicted output comports with a target or ideal output. The neural network 510 can perform a backward pass by determining which inputs (weights) most contributed to the loss of the neural network 510, and can adjust the weights so that the loss decreases and is eventually minimized.

A derivative of the loss with respect to the weights can be computed to determine the weights that contributed most to the loss of the neural network 510. After the derivative is computed, a weight update can be performed by updating the weights of the filters. For example, the weights can be updated so that they change in the opposite direction of the gradient. A learning rate can be set to any suitable value, with a high learning rate including larger weight updates and a lower value indicating smaller weight updates.

The neural network 510 can include any suitable neural or deep learning network. One example includes a convolutional neural network (CNN), which includes an input layer and an output layer, with multiple hidden layers between the input and out layers. The hidden layers of a CNN can include a series of convolutional, nonlinear, pooling (for downsampling), and fully connected layers. In other examples, the neural network 510 can represent any other neural or deep learning network, such as a transformer network, an autoencoder, a deep belief nets (DBNs), a recurrent neural network (RNN), an LLM, etc.

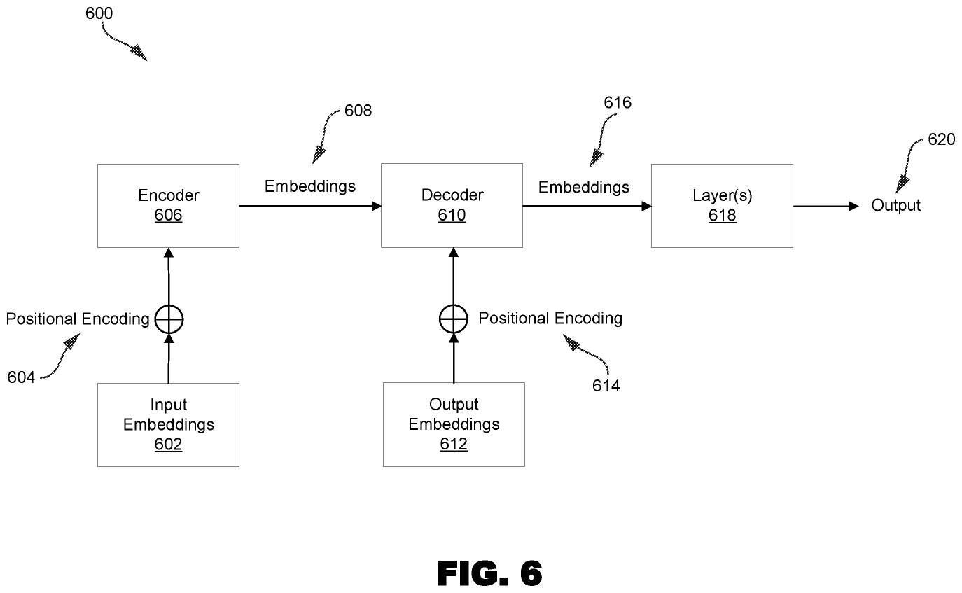

FIG. 6 is a diagram illustrating an example model architecture 600 that can be used to implement an LLM, such as the control LLM 202, any of the domain-specific LLMs 210, the LLM 304, etc. In this example, the model architecture 600 represents a transformer network architecture that can be used to implement an LLM. As shown, the model architecture 600 can include input embeddings 602 used as inputs to the model. The input embeddings 602 input values representing words and/or sentences, such as numbers or vectors representing words and/or sentences.

The input embeddings 602 can function like a dictionary that helps the model understand the meaning of words by placing them in an embedding space where similar words are located near each other. In some examples, the model can learn to create the input embeddings 602 during training so that similar vectors represent words with similar meanings.

The model can use positional encoding 604 to encode the position of each word in an input sequence from the input embeddings 602 as values such as a set of numbers, a vector, etc. The values generated by the positional encoding 604 can be fed into the model along with the input embeddings 602. By incorporating the positional encoding 604 into the model architecture 600, the model can more effectively understand the order of words in a sentence and generate grammatically correct and semantically meaningful output.

The model architecture 600 can include an encoder(s) 606 used to process the positionally encoded input embeddings 602 and generate embeddings 608. The encoder(s) 606 can be part of the model that processes input text and generates hidden states that capture the meaning and context of the text. For example, the encoder(s) 606 can include a feed-forward neural network that is part of the transformer model. In some examples, the encoder(s) 606 can implement multiple encoder layers. In some cases, the encoder(s) 606 can first tokenize the input text into a sequence of tokens, such as individual words or sub-words. The encoder(s) 606 can then apply one or more self-attention layers, which can generate hidden states that represent the input text at different levels of abstraction. In this way, the encoder(s) 606 can generate the embeddings 608 (e.g., a vector, a set of values, etc.) representing the semantics and position of words in one or more sentences.

The model architecture 600 can include output embeddings 612, which can include values representing words and/or sentences, such as numbers or vectors representing words and/or sentences. The output embeddings 612 can be similar to the input embeddings 602 and can also be processed by positional encoding 614 to encode the position of each word in a sequence from the output embeddings 612 as values such as a set of numbers, a vector, etc., which helps the model understand the order of words in a sentence. The output embeddings 612 can be used during a training phase of the model but can also be used during an inference phase. During training, a loss function can be computed based on the output embeddings 612 and used to update the model parameters to improve the accuracy of the model. During an inference phase, the output embeddings 612 can be used to generate the output text by mapping the model's predicted probabilities of each token to the corresponding token in the vocabulary.

The positionally encoded input embeddings 602 (e.g., the embeddings 608) and the positionally encoded output embeddings 612 can be fed to a decoder(s) 610 used to generate the output sequence based on the encoded input sequence. During training, the decoder(s) 610 can learn how to guess the next word of a sequence by looking at the words before it. In some examples, the decoder(s) 610 can generate natural language text based on the input sequence and any learned context.

The decoder(s) 610 can generate embeddings 616 and feed the embeddings 616 to one or more network layers 618. In some examples, the one or more network layers 618 can include a linear layer and a softmax function. The linear layer can map the embeddings 616 generated by the decoder(s) 610 to a higher-dimensional space, which can transform the embeddings 616 into the original input space. The softmax function can then be applied to generate a probability distribution for each output token in the vocabulary, which can result in an output 620. In some examples, the output 620 can include output tokens with probabilities.

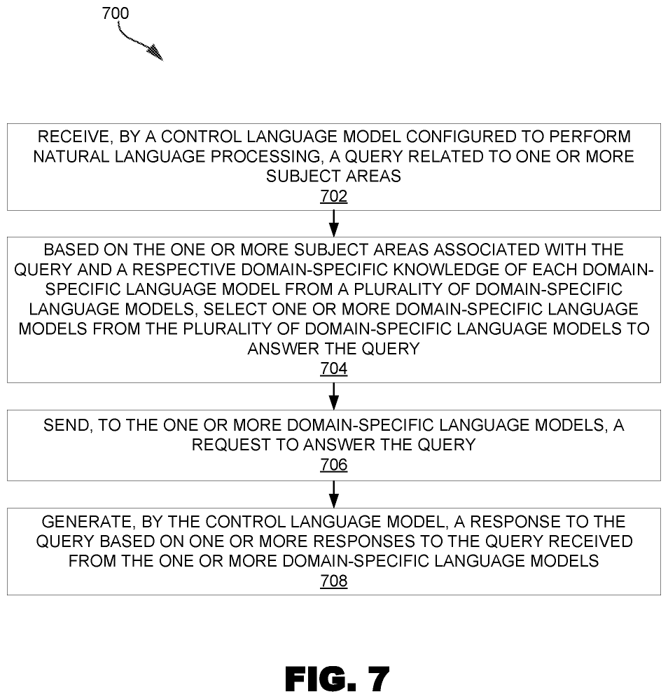

FIG. 7 is a flowchart illustrating an example process 700 for implementing a petrophysics assistant (e.g., petrophysics assistant 200), according to some examples of the present disclosure.

At block 702, the process 700 can include receiving, by a control language model (e.g., control LLM 202) configured to perform natural language processing, a query related to one or more subject areas. In some examples, the one or more subject areas can include one or more petrophysical subject areas such as, for example and without limitation, resistivity, NMR, porosity, continuity, fluid contact, permeability, formation lithology, density, saturation (e.g., water/fluid saturation, hydrocarbon saturation, etc.), pressure, magnetism and/or electromagnetism (EM), and/or formation testing, among others. In other examples, the one or more subject areas can include any other subject areas within petrophysics and/or in any other fields.

At block 704, the process 700 can include selecting, based on the one or more subject areas associated with the query and a respective domain-specific knowledge of each domain-specific language model from a plurality of domain-specific language models (e.g., domain-specific LLMs 210), selecting one or more domain-specific language models from the plurality of domain-specific language models to answer the query. In some examples, selecting the one or more domain-specific language models to answer the query can include determining, by the control language model, which subset of the plurality of domain-specific languages models can or should answer the query related to the one or more subject areas, has expertise/knowledge in the one or more subject areas, is trained to answer queries in the one or more subject areas, is trained with information relating to the one or more subject areas, has reasoning and/or knowledge capabilities in the one or more subject areas, and/or is best suited to answer the query related to the one or more subject areas, and selecting the subset of the plurality of domain-specific language models to answer the query. The control language model can then direct the query to the subset of the plurality of domain-specific language models to trigger the subset of the plurality of domain-specific language models to answer (or attempt to answer) the query.

In some examples, each domain-specific language model from the plurality of domain-specific language models can include a neural network, such as an LLM, that is trained with information about a different petrophysics domain and/or configured to answer queries associated with the different petrophysics domain. For example, each domain-specific language model can be trained with information about a different petrophysics domain(s) and/or configured to answer queries associated with the different petrophysics domain(s). In some cases, each neural network (e.g., each domain-specific language model) can be trained with different context-specific information and/or configured to answer queries associated with the different context-specific information. The different context-specific information can include, for example and without limitation, tool-specific information, wellbore-specific information, use case specific information, etc.

In some aspects, the control language model can include a neural network (e.g., an LLM) trained with petrophysics information and each domain-specific language model from the plurality of domain-specific language models can be trained with more specific petrophysics information than the control language model. For example, the control language model can be trained with general petrophysics information, such as petrophysics information from one or more petrophysics domains (e.g., topics, subject areas, concepts, principles, use cases, etc.) that is more general than (e.g., less specific than, less detailed than, less comprehensive than, less advanced than, less in depth than, at a higher level than, more generic than, etc.) the more specific petrophysics information used to train each of the domain-specific language model. In other words, the petrophysics information used to train the control language model can be more general than the petrophysics information used to train each domain-specific language model at least with regards to the petrophysics domain in which the domain-specific language model is trained/specialized.

In some aspects, the control language model and/or any of the plurality of domain-specific language models can include a transformer network. In some examples, the plurality of domain-specific language models can include a resistivity model (e.g., resistivity model 212) configured to answer questions relating to resistivity, an NMR model (e.g., NMR model 214) configured to answer questions relating to NMR, a porosity model (e.g., porosity model 216) configured to answer questions relating to porosity, a fluid contact model (e.g., fluid contact model 220) configured to answer questions relating to fluid contact, a permeability model (e.g., permeability model 222) configured to answer questions relating to permeability, a formation testing model (e.g., formation testing model 224) configured to answer questions relating to formation testing, and/or a continuity model (e.g., continuity model 218) configured to answer questions relating to continuity.

At block 706, the process 700 can include sending, to the one or more domain-specific language models, a request to answer the query. For example, the control language model can send a call, message, command, and/or instruction to the one or more domain-specific language models configured to trigger the one or more domain-specific language models to run on a device hosting the plurality of domain-specific language models and generate (or attempt to generate) one or more respective responses to the query.

At block 708, the process 700 can include generating, by the control language model, a response to the query based on one or more responses to the query received from the one or more domain-specific language models. For example, the control language model can receive one or more query responses from the one or more domain-specific language models and use the one or more query responses to formulate a response by coalescing the one or more query responses, summarizing the one or more query responses, revising the one or more query responses, preparing information from the one or more query responses into a response in dialogue form, and/or otherwise prepare a response to the query.

In some examples, the control language model can generate the response to the query based on information from the one or more responses and petrophysics information learned by the control language model. For example, the control language model can use information from each of the one or more responses (or at least some of the one or more responses) to generate a response that is formulated in part based on petrophysics information learned and/or ascertained by the control language model.

In some aspects, the process 700 can include performing, by each of the one or more domain-specific language models and based on the query, a respective lookup in a knowledge base (e.g., knowledge base 230) of petrophysics information, and generating, by the one or more domain-specific language models, the one or more responses based on each respective lookup in the knowledge base of petrophysics information.

In some aspects, the one or more domain-specific language models can include a subset of domain-specific language models from the plurality of domain-specific language models and the one or more responses can include multiple responses from different domain-specific language models of the subset of domain-specific language models. In some examples, generating the response to the query can include combining information from the multiple responses into a combined response.

In some aspects, the control language model can include a model (e.g., multimodal model 206) configured to convert image data into text data describing the image data, and the query can include visual information (e.g., image data) collected from a wellbore site. In some cases, the visual information can include, for example and without limitation, a visual petrophysical log, graph, map, chart, and/or other graphical information. For example, the visual information can include a visual log obtained from the logging tools 126. In some cases, the visual log can include an indication of a portion of the visual log related to the query and/or identified for consideration with regards to the query, such as a highlighted portion of the visual log, a comment in the visual log, a tag in the visual log, metadata added to the visual log, a note in the visual log, a formatting of a portion of the visual log, a color-coding of a portion of the visual log, etc.

In some examples, selecting the one or more domain-specific language models and/or generating the response can be further based on the visual information. For example, the model configured to convert image data into text data can convert the visual information into text describing, summarizing, identifying, and/or characterizing the visual information (and/or a portion thereof). The converted text can then be included in the query and/or provided with the query to the one or more domain-specific language models, which can use the converted text and any other information in the query to generate a respective response to the query.

In some examples, the control language model and the plurality of domain-specific language models can be part of a petrophysics assistant (e.g., petrophysics assistant 200), and can run on a computing device, such as a server, a tool (e.g., a logging tool, a sensor system, etc.) with computing capabilities, a client device, any edge device, and/or any other computing device. For example, the petrophysics assistant can be compressed to run on edge devices that have less compute resources (e.g., more compute resource constraints) than higher-end devices such as servers. In some examples, an edge device may not have enough compute resources to run the control language model and the plurality of domain-specific language models at the same time. However, by allowing the control language model to selectively direct queries to a subset of the domain-specific language models and thus trigger only a subset of the domain-specific language models to run at the edge device at a given time (e.g., for a given query/call), the control language model can reduce the amount of resources used at the edge device to answer a query at any given time. This in turn can allow the edge device to run the selected subset of domain-specific language models at a given time despite resource constraints at the edge device, prevent errors/failures that may otherwise result if the edge device attempted to run all of the plurality of domain-specific language models at the same time (or a model with the size/parameters and/or capabilities of all of the plurality of domain-specific language models) given the resource constraints at the edge device, reduce the latency when running the petrophysics assistant (compared to simultaneously running all of the plurality of domain-specific language models or running a model with the size/parameters and/or capabilities of all of the domain-specific language models), among other benefits.

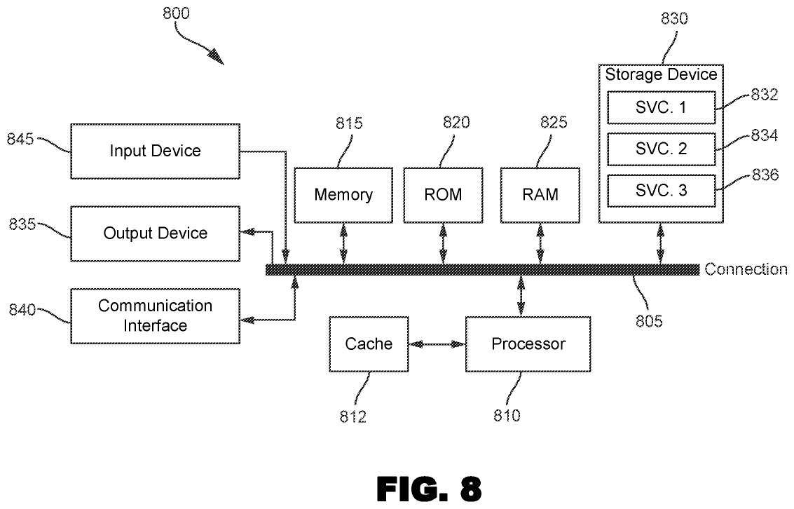

FIG. 8 illustrates an example computing device architecture 800 which can be employed to perform any of the systems and techniques described herein. In some examples, the computing device architecture can be integrated with the electromagnetic imager tools described herein. Further, the computing device can be configured to implement the techniques of controlling borehole image blending through machine learning described herein.

The components of the computing device architecture 800 are shown in electrical communication with each other using a connection 805, such as a bus. The example computing device architecture 800 includes a processing unit (CPU or processor) 810 and a computing device connection 805 that couples various computing device components including the computing device memory 815, such as read only memory (ROM) 820 and random-access memory (RAM) 825, to the processor 810.

The computing device architecture 800 can include a cache of high-speed memory connected directly with, in close proximity to, or integrated as part of the processor 810. The computing device architecture 800 can copy data from the memory 815 and/or the storage device 830 to the cache 812 for quick access by the processor 810. In this way, the cache can provide a performance boost that avoids processor 810 delays while waiting for data. These and other modules can control or be configured to control the processor 810 to perform various actions. Other computing device memory 815 may be available for use as well. The memory 815 can include multiple different types of memory with different performance characteristics. The processor 810 can include any general-purpose processor and a hardware or software service, such as service 1 832, service 2 834, and service 3 836 stored in storage device 830, configured to control the processor 810 as well as a special-purpose processor where software instructions are incorporated into the processor design. The processor 810 may be a self-contained system, containing multiple cores or processors, a bus, memory controller, cache, etc. A multi-core processor may be symmetric or asymmetric.

To enable user interaction with the computing device architecture 800, an input device 845 can represent any number of input mechanisms, such as a microphone for speech, a touch-sensitive screen for gesture or graphical input, keyboard, mouse, motion input, speech and so forth. An output device 835 can also be one or more of a number of output mechanisms known to those of skill in the art, such as a display, projector, television, speaker device, etc. In some instances, multimodal computing devices can enable a user to provide multiple types of input to communicate with the computing device architecture 800. The communications interface 840 can generally govern and manage the user input and computing device output. There is no restriction on operating on any particular hardware arrangement and therefore the basic features here may easily be substituted for improved hardware or firmware arrangements as they are developed.

Storage device 830 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 825, read only memory (ROM) 820, and hybrids thereof. The storage device 830 can include services 832, 834, 836 for controlling the processor 810. Other hardware or software modules are contemplated. The storage device 830 can be connected to the computing device connection 805. In one aspect, a hardware module that performs a particular function can include the software component stored in a computer-readable medium in connection with the necessary hardware components, such as the processor 810, connection 805, output device 835, and so forth, to carry out the function.

For clarity of explanation, in some instances the present technology may be presented as including individual functional blocks including functional blocks comprising devices, device components, steps or routines in a method implemented in software, or combinations of hardware and software.

In some instances, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can include hardware, firmware and/or software, and can take any of a variety of form factors. Typical examples of such form factors include laptops, smart phones, small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific examples and aspects thereof, but those skilled in the art will recognize that the application is not limited thereto. Thus, while illustrative examples and aspects of the application have been described in detail herein, it is to be understood that the disclosed concepts may be otherwise variously embodied and employed, and that the appended claims are intended to be construed to include such variations, except as limited by the prior art. Various features and aspects of the above-described subject matter may be used individually or jointly. Further, examples and aspects of the systems and techniques described herein can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate examples, the methods may be performed in a different order than that described.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The various illustrative logical blocks, modules, circuits, and algorithm steps described in connection with the examples disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the method, algorithms, and/or operations described above. The computer-readable data storage medium may form part of a computer program product, which may include packaging materials.

The computer-readable medium may include memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

Methods and apparatus of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Such methods may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

In the above description, terms such as “upper,” “upward,” “lower,” “downward,” “above,” “below,” “downhole,” “uphole,” “longitudinal,” “lateral,” and the like, as used herein, shall mean in relation to the bottom or furthest extent of the surrounding wellbore even though the wellbore or portions of it may be deviated or horizontal. Correspondingly, the transverse, axial, lateral, longitudinal, radial, etc., orientations shall mean orientations relative to the orientation of the wellbore or tool.

The term “coupled” is defined as connected, whether directly or indirectly through intervening components, and is not necessarily limited to physical connections. The connection can be such that the objects are permanently connected or releasably connected. The term “outside” refers to a region that is beyond the outermost confines of a physical object. The term “inside” indicates that at least a portion of a region is partially contained within a boundary formed by the object. The term “substantially” is defined to be essentially conforming to the particular dimension, shape or another word that substantially modifies, such that the component need not be exact. For example, substantially cylindrical means that the object resembles a cylinder, but can have one or more deviations from a true cylinder.

The term “radially” means substantially in a direction along a radius of the object, or having a directional component in a direction along a radius of the object, even if the object is not exactly circular or cylindrical. The term “axially” means substantially along a direction of the axis of the object. If not specified, the term axially is such that it refers to the longer axis of the object.

Although a variety of information was used to explain aspects within the scope of the appended claims, no limitation of the claims should be implied based on particular features or arrangements, as one of ordinary skill would be able to derive a wide variety of implementations. Further and although some subject matter may have been described in language specific to structural features and/or method steps, it is to be understood that the subject matter defined in the appended claims is not necessarily limited to these described features or acts. Such functionality can be distributed differently or performed in components other than those identified herein. The described features and steps are disclosed as possible components of systems and methods within the scope of the appended claims.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Illustrative aspects of the disclosure include:

Aspect 1. A method comprising: receiving, by a control language model configured to perform natural language processing, a query related to one or more subject areas; based on the one or more subject areas associated with the query and a respective domain-specific knowledge of each domain-specific language model from a plurality of domain-specific language models, selecting one or more domain-specific language models from the plurality of domain-specific language models to answer the query; sending, to the one or more domain-specific language models, a request to answer the query; and generating, by the control language model, a response to the query based on one or more responses to the query received from the one or more domain-specific language models.

Aspect 2. The method of Aspect 1, wherein each domain-specific language model from the plurality of domain-specific language models comprises a neural network that is at least one of trained with information about a different petrophysics domain and configured to answer queries associated with the different petrophysics domain.

Aspect 3. The method of any of Aspects 1 or 2, wherein each domain-specific language model from the plurality of domain-specific language models comprises a neural network that is at least one of trained with different context-specific information and configured to answer queries associated with the different context-specific information, wherein the different context-specific information comprises at least one of tool-specific information and wellbore-specific information.

Aspect 4. The method of any of Aspects 1 to 3, wherein the control language model is trained with petrophysics information and each domain-specific language model from the plurality of domain-specific language models is trained with more specific petrophysics information than the control language model.

Aspect 5. The method of any of Aspects 1 to 4, wherein the response to the query is generated based on information from the one or more responses and petrophysics information learned by the control language model to generate the response.

Aspect 6. The method of any of Aspects 1 to 5, wherein the one or more domain-specific language models comprise a subset of domain-specific language models from the plurality of domain-specific language models and the one or more responses comprise multiple responses from different domain-specific language models of the subset of domain-specific language models, and wherein generating the response to the query comprises combining information from the multiple responses into a combined response.

Aspect 7. The method of any of Aspects 1 to 6, wherein the control language model further comprises a model configured to convert image data into text data describing the image data, wherein the query comprises visual information collected from a wellbore site, and wherein at least one of selecting the one or more domain-specific language models and generating the response is further based on the visual information.

Aspect 8. The method of Aspect 7, wherein the visual information comprises at least one of a petrophysical log, a petrophysical map, a petrophysical chart, and a petrophysical image.

Aspect 9. The method of any of Aspects 1 to 8, wherein at least one of the control language model and one or more of the plurality of domain-specific language models comprises a transformer network, and wherein the plurality of domain-specific language models comprises at least one of a resistivity model configured to answer questions relating to resistivity, a nuclear magnetic resonance (NMR) model configured to answer questions relating to NMR, a porosity model configured to answer questions relating to porosity, a fluid contact model configured to answer questions relating to fluid contact, a permeability model configured to answer questions relating to permeability, a formation testing model configured to answer questions relating to formation testing, and a continuity model configured to answer questions relating to continuity.

Aspect 10. The method of any of Aspects 1 to 9, further comprising: based on the query, performing, by each of the one or more domain-specific language models, a respective lookup in a knowledge base of petrophysics information; and generating, by the one or more domain-specific language models, the one or more responses based on each respective lookup in the knowledge base of petrophysics information.

Aspect 11. A system comprising: memory; and one or more processors coupled to the memory, the one or more processors configured to: receive, by a control language model configured to perform natural language processing, a query related to one or more subject areas; based on the one or more subject areas associated with the query and a respective domain-specific knowledge of each domain-specific language model from a plurality of domain-specific language models, selecting one or more domain-specific language models from the plurality of domain-specific language models to answer the query; send, to the one or more domain-specific language models, a request to answer the query; and generate, by the control language model, a response to the query based on one or more responses to the query received from the one or more domain-specific language models.

Aspect 12. The system of Aspect 11, wherein each domain-specific language model from the plurality of domain-specific language models comprises a neural network that is at least one of trained with information about a different petrophysics domain and configured to answer queries associated with the different petrophysics domain.

Aspect 13. The system of any of Aspects 11 or 12, wherein each domain-specific language model from the plurality of domain-specific language models comprises a neural network that is at least one of trained with different context-specific information and configured to answer queries associated with the different context-specific information, wherein the different context-specific information comprises at least one of tool-specific information and wellbore-specific information.

Aspect 14. The system of any of Aspects 11 to 13, wherein the control language model is trained with petrophysics information and each domain-specific language model from the plurality of domain-specific language models is trained with more specific petrophysics information than the control language model.

Aspect 15. The system of any of Aspects 11 to 14, wherein the response to the query is generated based on information from the one or more responses and petrophysics information learned by the control language model to generate the response.

Aspect 16. The system of any of Aspects 11 to 15, wherein the one or more domain-specific language models comprise a subset of domain-specific language models from the plurality of domain-specific language models and the one or more responses comprise multiple responses from different domain-specific language models of the subset of domain-specific language models, and wherein generating the response to the query comprises combining information from the multiple responses into a combined response.

Aspect 17. The system of any of Aspects 11 to 16, wherein the control language model further comprises a model configured to convert image data into text data describing the image data, wherein the query comprises visual information collected from a wellbore site, wherein at least one of selecting the one or more domain-specific language models and generating the response is further based on the visual information.

Aspect 18. The system of Aspect 17, wherein the visual information comprises at least one of a petrophysical log, a petrophysical map, a petrophysical chart, and a petrophysical image.

Aspect 19. The system of any of Aspects 11 to 18, wherein at least one of the control language model and one or more of the plurality of domain-specific language models comprises a transformer network, and wherein the plurality of domain-specific language models comprises at least one of a resistivity model configured to answer questions relating to resistivity, a nuclear magnetic resonance (NMR) model configured to answer questions relating to NMR, a porosity model configured to answer questions relating to porosity, a fluid contact model configured to answer questions relating to fluid contact, a permeability model configured to answer questions relating to permeability, a formation testing model configured to answer questions relating to formation testing, and a continuity model configured to answer questions relating to continuity.

Aspect 20. The system of any of Aspects 11 to 19, wherein the one or more processors are further configured to: based on the query, perform, by each of the one or more domain-specific language models, a respective lookup in a knowledge base of petrophysics information; and generate, by the one or more domain-specific language models, the one or more responses based on each respective lookup in the knowledge base of petrophysics information.

Aspect 21. A non-transitory computer-readable medium comprising instructions which, when executed by one or more processors, cause the one or more processors to perform a method according to any of Aspects 1 to 10.

Aspect 22. A system comprising means for performing a method according to any of Aspects 1 to 10.

Aspect 23. A computer-program product comprising instructions which, when executed by one or more computing devices, cause the one or more computing devices to perform a method according to any of Aspects 1 to 10.

What is claimed is:

1. A method comprising:
receiving, by a control language model configured to perform natural language processing, a query related to one or more subject areas;
based on the one or more subject areas associated with the query and a respective domain-specific knowledge of each domain-specific language model from a plurality of domain-specific language models, selecting one or more domain-specific language models from the plurality of domain-specific language models to answer the query;
sending, to the one or more domain-specific language models, a request to answer the query; and
generating, by the control language model, a response to the query based on one or more responses to the query received from the one or more domain-specific language models.

2. The method of claim 1, wherein each domain-specific language model from the plurality of domain-specific language models comprises a neural network that is at least one of trained with information about a different petrophysics domain and configured to answer queries associated with the different petrophysics domain.

3. The method of claim 1, wherein each domain-specific language model from the plurality of domain-specific language models comprises a neural network that is at least one of trained with different context-specific information and configured to answer queries associated with the different context-specific information, wherein the different context-specific information comprises at least one of tool-specific information and wellbore-specific information.

4. The method of claim 1, wherein the control language model is trained with petrophysics information and each domain-specific language model from the plurality of domain-specific language models is trained with more specific petrophysics information than the control language model.

5. The method of claim 1, wherein the response to the query is generated based on information from the one or more responses and petrophysics information learned by the control language model to generate the response.

6. The method of claim 1, wherein the one or more domain-specific language models comprise a subset of domain-specific language models from the plurality of domain-specific language models and the one or more responses comprise multiple responses from different domain-specific language models of the subset of domain-specific language models, and wherein generating the response to the query comprises combining information from the multiple responses into a combined response.

7. The method of claim 1, wherein the control language model further comprises a model configured to convert image data into text data describing the image data, wherein the query comprises visual information collected from a wellbore site, and wherein at least one of selecting the one or more domain-specific language models and generating the response is further based on the visual information.

8. The method of claim 7, wherein the visual information comprises at least one of a petrophysical log, a petrophysical map, a petrophysical chart, and a petrophysical image.

9. The method of claim 1, wherein at least one of the control language model and one or more of the plurality of domain-specific language models comprises a transformer network, and wherein the plurality of domain-specific language models comprises at least one of a resistivity model configured to answer questions relating to resistivity, a nuclear magnetic resonance (NMR) model configured to answer questions relating to NMR, a porosity model configured to answer questions relating to porosity, a fluid contact model configured to answer questions relating to fluid contact, a permeability model configured to answer questions relating to permeability, a formation testing model configured to answer questions relating to formation testing, and a continuity model configured to answer questions relating to continuity.

10. The method of claim 1, further comprising:
based on the query, performing, by each of the one or more domain-specific language models, a respective lookup in a knowledge base of petrophysics information; and
generating, by the one or more domain-specific language models, the one or more responses based on each respective lookup in the knowledge base of petrophysics information.

11. A system comprising:
a memory; and
one or more processors coupled to the memory, the one or more processors configured to:
receive, by a control language model configured to perform natural language processing, a query related to one or more subject areas;
based on the one or more subject areas associated with the query and a respective domain-specific knowledge of each domain-specific language model from a plurality of domain-specific language models, selecting one or more domain-specific language models from the plurality of domain-specific language models to answer the query;
send, to the one or more domain-specific language models, a request to answer the query; and
generate, by the control language model, a response to the query based on one or more responses to the query received from the one or more domain-specific language models.

12. The system of claim 11, wherein each domain-specific language model from the plurality of domain-specific language models comprises a neural network that is at least one of trained with information about a different petrophysics domain and configured to answer queries associated with the different petrophysics domain.

13. The system of claim 11, wherein each domain-specific language model from the plurality of domain-specific language models comprises a neural network that is at least one of trained with different context-specific information and configured to answer queries associated with the different context-specific information, wherein the different context-specific information comprises at least one of tool-specific information and wellbore-specific information.

14. The system of claim 11, wherein the control language model is trained with petrophysics information and each domain-specific language model from the plurality of domain-specific language models is trained with more specific petrophysics information than the control language model.

15. The system of claim 11, wherein the response to the query is generated based on information from the one or more responses and petrophysics information learned by the control language model to generate the response.

16. The system of claim 11, wherein the one or more domain-specific language models comprise a subset of domain-specific language models from the plurality of domain-specific language models and the one or more responses comprise multiple responses from different domain-specific language models of the subset of domain-specific language models, and wherein generating the response to the query comprises combining information from the multiple responses into a combined response.

17. The system of claim 11, wherein the control language model further comprises a model configured to convert image data into text data describing the image data, wherein the query comprises visual information collected from a wellbore site, wherein at least one of selecting the one or more domain-specific language models and generating the response is further based on the visual information, wherein the visual information comprises at least one of a petrophysical log, a petrophysical map, a petrophysical chart, and a petrophysical image.

18. The system of claim 11, wherein at least one of the control language model and one or more of the plurality of domain-specific language models comprises a transformer network, and wherein the plurality of domain-specific language models comprises at least one of a resistivity model configured to answer questions relating to resistivity, a nuclear magnetic resonance (NMR) model configured to answer questions relating to NMR, a porosity model configured to answer questions relating to porosity, a fluid contact model configured to answer questions relating to fluid contact, a permeability model configured to answer questions relating to permeability, a formation testing model configured to answer questions relating to formation testing, and a continuity model configured to answer questions relating to continuity.

19. The system of claim 11, wherein the one or more processors are further configured to:
based on the query, perform, by each of the one or more domain-specific language models, a respective lookup in a knowledge base of petrophysics information; and
generate, by the one or more domain-specific language models, the one or more responses based on each respective lookup in the knowledge base of petrophysics information.

20. A non-transitory computer-readable medium comprising instructions which, when executed by one or more processors, cause the one or more processors to:
receive, by a control language model configured to perform natural language processing, a query related to one or more subject areas;
based on the one or more subject areas associated with the query and a respective domain-specific knowledge of each domain-specific language model from a plurality of domain-specific language models, selecting one or more domain-specific language models from the plurality of domain-specific language models to answer the query;
send, to the one or more domain-specific language models, a request to answer the query; and
generate, by the control language model, a response to the query based on one or more responses to the query received from the one or more domain-specific language models.
